(19) United States
(12) Patent Application Publication
(10) Pub. No.: US 2010/0293068 A1
(43) Pub. Date: Nov. 18, 2010

(54) Mall Bid

(76) Inventors: Niko Drakoulis, Arlington Heights, IL (US); John Karantonis, Chicago, IL (US); Georgios Stoikos, Serres (GR)

Correspondence Address: YOUNG BASILE, 3001 WEST BIG BEAVER ROAD, SUITE 624, TROY, MI, 48084, US

(21) Appl. No.: 12/781,408

(22) Filed: May 17, 2010

Related U.S. Application Data
(60) Provisional application No. 61/178,724, filed on May 15, 2009.

(51) Int. Cl. G06Q 30/00

(52) U.S. Cl. 705/26

(57) ABSTRACT

A mall bid server is coupled to retailers within a geographic boundary of a mall. The mall server receives bids from authenticated consumers via wireless communication devices for bid products offered during a bid event. The winning bid from one consumer is selected and allows the consumer to pick up the bid product at the participating retailer at the bid price.

### CROSS REFERENCE TO CO-PENDING APPLICATION

This application claims the priority benefit of the filing date of co-pending U.S. Provisional Patent Application Ser. No. 61/178,724, filed on May 15, 2009, in the names of Niko Drakoulis, John Karantonis and George Stoikos, for “Mall Bid”, the entire contents of which are incorporated herein by reference.

### BACKGROUND

The present mall bid process and apparatus relates to methods and apparatus for facilitating commercial transactions, particularly retail transactions at shopping malls using mobile wireless consumer devices and consumer computers.

Retail shopping malls have been around for over 50 years and have proven extremely popular with consumers for many reasons. One reason for the shopping mall's popularity is that a consumer can visit a mall and purchase a number of completely different products from different retailers without having to drive all over town to widely spaced retailers to complete his or her purchases. This is much more convenient in addition to saving the consumer's time and gasoline. Another factor in favor of a shopping mall's popularity is that it affords the consumer the ability to compare the same product at several different retailers for price, quality, and availability. In addition, a consumer can actually try on clothes and hold and inspect the physical product he/or might be interested in before making a purchase.

While mail order catalog sales have been available to the consumer for a longer time than shopping malls, catalog sales have represented only a small percentage of the retail market. Even then it is typically still necessary for retailers to have physical store to handle exchanges and returns of catalog ordered products.

Recently, Internet purchases and television networks, such as The Home Shopping Network, have increased in popularity and have caused a significant drop in consumer traffic and sales volume at shopping malls. The reasons for this drip off are many, but include the convenience of shopping from home during inclement weather, saving gasoline and time, searching for a number of different manufacturers who offer the same product across the entire country, and comparing multiple manufacturers on price, availability, and quality factors.

Retailers know that while consumers may initially travel to a retail store or to a mall for the purpose of purchasing a single product, it is common for such consumers to actually purchase numerous products when they are exposed to such products as they wander through the mall or store, encounter sales, etc.

Thus, it would be desirable to combine the current trend to Internet retail sales with the popularity of portable wireless devices, such as cell phones, PDA's, etc., to encourage consumers to travel to a shopping mall.

### SUMMARY OF THE INVENTION

A method of selling products comprises the steps:

defining a localized area within a predetermined geographic boundary containing at least one product retailer;

providing a first communication pathway between a server and at least one consumer communication device,

establishing a second communication pathway between the server and the at least one retailer processor;

allowing the at least one retailer within the mall to offer at least one product in a bid event;

establishing bid event parameters;

accepting the bids for the at least one product in the bid event from consumers;

authorizing the purchase of the at least one product at the conclusion of the bid event at a bid price; and completing the purchase transaction of the product by the consumer who placed the bid.

The step of defining the localized area defines the localized area as the perimeter of a fixed location shopping mall.

In the method the products offered during the bid event in the localized area during the bid event are publicly displayed in the localized are during the bid event.

The then current highest bid for each bid product during the bid event can also be displayed.

The method further determines the geographic location of a consumer and allows the consumer to enter a bid during the bid event when the consumer is within a predetermined distance of the localized area.

The method allows a consumer to place a bid during the bid event only when the consumer is within the perimeter of the localized area.

The method further provides downloading of an application program to a wireless mobile device carried by a consumer to facilitate bidding by the consumer during the bid event.

The method further provides downloading the application program to at least one of a consumer mobile wireless device and a consumer remote processor based device.

The method of claim 1 further comprising the step of: detecting the presence of a consumer within the localized area. The method of then automatically downloading current bid event information to a consumer device containing the application program when the consumer is detected within the localized area.

The method further comprises the steps of establishing a bid period having a start time and an end time; communicating characteristics of the at least one product offer during the bid period to consumers.

The step of completing the purchase transaction for a bid product comprises the steps of: verifying the credentials of the consumer with an acceptable bid for the at least one product from the at least one retailer and verifying consumer payment for the at least one product.

The method is capable of receiving wireless bids from consumers for products.

The method can receive bids from consumers for the bid event products through the Internet.

The method defines the bid event as an auction having an end time. The method further comprises the step of establishing a pickup end time for the consumer who made the highest bid for a product to pickup the product from the mall retailer.

The method further includes the step of displaying auction bids for each auction product during the auction.

The method can further comprise the steps of providing a virtual bid mall control; and providing communication pathways between the virtual bid mall control and any of the consumer wireless communication devices, consumer processor based devices, and the mall server.

An apparatus for commercial product transactions comprises a mall server; a computer network coupling at least a communication network of at least one retailer within a localized area within a predetermined geographic boundary defining a shopping mall. a first communication pathway providing information between the mall server and at least one of a mobile wireless device and a computer processor associated with a consumer; and a retailer computer network; a second communication pathway providing information between the mall server at and least one of a mobile wireless device and a computer processor associated with a consumer; and the retailer network to facilitate the establishment of a product bid period offering at least one product from the at least one retailer for sale; the mall server facilitating bid event characteristics through the first communication pathway between the at least one consumer device and the mall server to take bids from the consumer via the at least one consumer device for the at least one product offered during the bid period; and the at least one consumer communication device including a downloadable application which is capable of receiving bid event characteristic information from the mall server and to enter bids from the consumer to the mall server for the at least one product offered during the bid event.

The apparatus further includes a virtual bid management control server disposed in data communication with any of the consumer communication devices and the mall server to facilitate information exchange between the at least one consumer device and the mall server;

An apparatus for purchasing products comprises each consumer having a communication device; a server transmitting product information offered during a bid event from a plurality of retailers located within a predetermined geographic boundary; and the server receiving product purchase bids from the consumers for the products offered during a bid event by a first communication pathway; and authorizing the purchase of the products by consumers at the completion of the bid event;

The apparatus further includes the retailers within the predetermined geographic boundary being coupled by a second communication pathway with the mall server for exchanging information relating to the products offered by the retailers in a bid event and purchase information relating to consumer's bids received from the server.

### BRIEF DESCRIPTION OF THE DRAWING

The various features, advantages and other uses of the present mall bid process and apparatus will be understood from the following description and drawing in which:

FIG. 1 is a block diagram of an application of a mall bid program;

FIG. 2 is a pictorial representation of a typical mall layout using the mall bid program;

FIG. 3 is a block diagram depicting the sequence of operation of the mall bid program;

FIG. 4 is a block diagram depicting the consumer enrollment sequence in the mall bid program; and

FIG. 5 is a pictorial representation of an alternate bidder and multiple mall system using the mall bid program.

### DETAILED DESCRIPTION

The present mall bid process and apparatus is useful in generating and driving consumers to a shopping mall, to increase the sale of products and services offered at the mall.

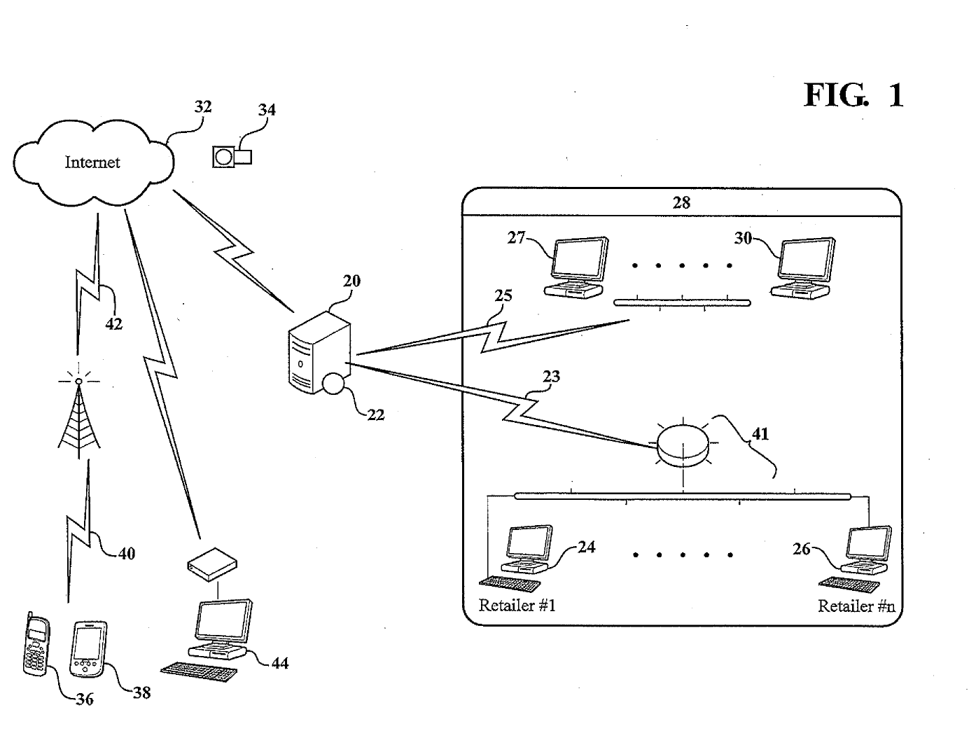

As shown in FIG. 1, a server or central processing unit 20 containing a mall bid application or program 22 receives a variety of inputs, by a first communication link or pathway 35 from a variety of communication devices, such as wireless mobile communication devices including a cell phone 36, a PDA 38, Ipad etc., which communicate through a mobile wireless communication network 40 to the Internet 32 by a hardline, satellite and/or wireless communication system 42, and from the Internet 32 to the server 20.

The server 20 also is coupled via a second communication link or pathway 23 to computer networks or processors in one or more retailers 24 and 26A-26G located within a mall 28. The retailer computers maybe coupled to a local area network 41 within the mall 28. A plurality of outputs are provided by the server 20 on a third communication link pathway 25, such as a video output to one or more audio/video screens or monitors 27, 29, 30, 31 and 33, by way of example, positioned at various locations within the mall 28 or at one or more locations within a single retailer.

The server 20 may be physically located within the premises of the mall 28 or at a location remote from the mall 28.

The server 20 is connectable to the Internet 32 by wireless or hardwired connections. A mall bid website 34 is accessible through the Internet 32 by the server 20. Alternately, the server 20 can support the mall bid website 34.

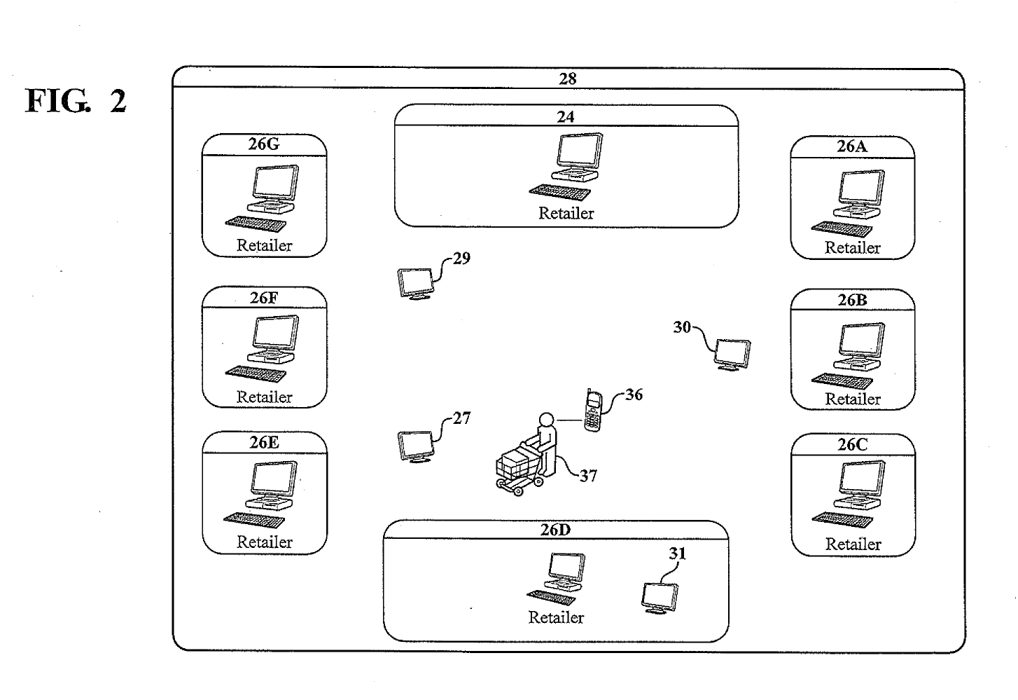

A consumer can access the mall bid application 22 by a variety of communication devices, such as wireless mobile communication devices including a cell phone 36, an PDA 38, iPad, etc., which communicate through a mobile wireless communication network 40 to the Internet 32 by a hardline, satellite and/or wireless communication system 42. The consumers communicating with the mall bid application 22 on the server 20 can be defined as on-premise consumers, such as consumer 37 shown in FIG. 2, or consumers located within geographic boundary of the mall 28, as well as off-premise consumers who are using a home or office based PC or laptop 44, or consumers using their wireless mobile devices 36 and 38, but are physically outside of the geographic boundary of the mall 28.

The consumers may also be divided into “user groups” which are defined as any segment of the total population of users who can bid on products offered via the mall bid application 22 irrespective of the consumers interface. For example, a particular user group may be a segment of consumers who have downloaded a customized, dedicated mall bid application, or who are registered to access to web-based mall bid applet, or who use a third party application developed through and API. User groups may be distinct from active product bidders, as described hereafter, because the application or web servers could potentially be integrated or coupled with other location base services, such as MyAkoo remote, Facebook, Twitter, etc., through an API that enabled them to enroll. Some users or user groups may receive notice of active bid programs via these other applications, but decide not to actively bid in any individual bid program at the time of the notice.

The consumer may also communicate with the mall bid application 22 on the website 34 by a desktop or other fixed location computing device 44. The desktop computer 44 is connectable to the Internet 32 by cable or modem connections, for example.

Referring briefly to FIG. 2, there is a depicted a typical “mall” 28 as used with the present mall bid application 22. The mall 28 is defined as a group of merchants or retailers 24, or 26A-26G, with any number of retailers being able to become associated by physical geographic location or by individual participation as a so-called “mall”. In a general meaning of a “mall”, the mall 28 can include a group of merchants or retailers 24, 26A-26G located within a defined physical geographic location or perimeter 50. The perimeter may take any configuration. The term “mall” 28 as used herein may also include one or a plurality of retailers 24, 26A-26G located in an open, uncovered single mall like structure, such as individual retail stores in a downtown area, but generally in close proximity to each other. The term “mall” 28 may also be a group of retailers 24, 26A-26G having individual stores, kiosks, or other retail facilities in a single large covered building.

The term “mall”, as used herein, may also include a single retailer, such as a single retailer having multiple departments within a single building. Such a single retailer can be in a stand alone building in which the building defines the geographic boundaries of a “mall” or a large or single multi-story building which forms a part of a larger mall containing other retailers.

The geographic coordinates of the perimeter or boundary of the mall 28 is determined by the sewer 20 using GPS coordinates or provided to the server 20 from another source.

For the purposes of the present Mall Bid process, the term “products” will be understood to mean any type of goods and services. For example, products can include any physical goods which are available at retailers, such as clothes, lawn mowers, electronic products books, etc., as well as services offered at a mall, such a salon services, etc. (C)

The mall server 20 is coupled in communication via the second communicating pathway 25 with a processor or server at each retailer 24, 26A, etc, through a local area network 41 at the mall 28. The communication network between the mall server 20 and the retailer servers or CPU's can be via hardline connection, Internet, Ethernet, etc. The retail processors or servers can be part of the computer network employed by each retailer for its internal operations. An application program will be installed in each retailer server to facilitate communication with the mall server 20. The installed application program in each retail or server functions to enable each retailer 24, 26, etc., to provide products for bid during a bid period via the mall server 20. In addition, the application program will enable to the retailer to monitor the progress of each bid period or auction offered through the mall server 20, the then current highest bid for the retailer's offered products, and other marketing and sales information.

As described hereafter in step 60 of the subject mall bid application sequence, participating mall retailers are defined as part of the mall bid program. This can be done by downloading a mall bid application to the server or computer network of each retailer 24, 26A-26G, within the mall 28. This does not, however, require each retailer to participate in each bid program by offering products for sale or auction during any bid program. This enables various subsets of retailers and consumer bidders to be set up in any bid program. For example, one subset could include all enrolled retailers and all enrolled consumer bidders whether on-premise or off-premise of the mall 20, in active bid program relative to all products made available for the bid program at the specific mall 28 by the retailers. Another subset could define some of the enrolled retailers and a target set of consumer bidders to a specific bid event for a specific set of products or category of product at the mall 28. Yet another subset could define some of the enrolled retailers in a target set of enrolled consumer bidders, such as “only off-premise bidders” to a specific bid event for a specific set of products or category of products at the mall 28.

This ability to create subsets of retailers and consumer/bidders enables the mall bid program to recognize that some products or retailers may not be relevant to the entire population of bidders, which may be due to attributes in a certain geographic mall boundary or because some consumers prefer to bid from the comfort of their living room and therefore a certain segment of potential bidders may be notified first of an upcoming bid event. Thus, all previous bidders in prior bid events may not necessarily be notified to participate in all future bid events. The mall bid application 22 enables segmented offers and consumer notifications based on certain probabilities and attributes associated with previous bidders.

In the present mall bid application, one or more of the retailers 24, 26A-26G may provide one or more products or services to be made available to the mall bid auction 22. For example, retailer 24 can offer a men's leather jacket for the mall bid auction. Retailer number 26A can offer a lawn mower. Any products sold by any of the retailers 24, 26A-26G may be selected by each retailer for inclusion in a single mall bid auction.

In an alternate bid process, the retailer software can provide one or more products for direct purchase by qualified consumers during a bid period. This enables each retailer to offer flash sales which may run for only a short period of time, such as one hour, two hours, etc. as described above for the various possible subsets of retailers and consumers, the alternate bid process can be tailored to offer flash sales of certain products to only certain bidders.

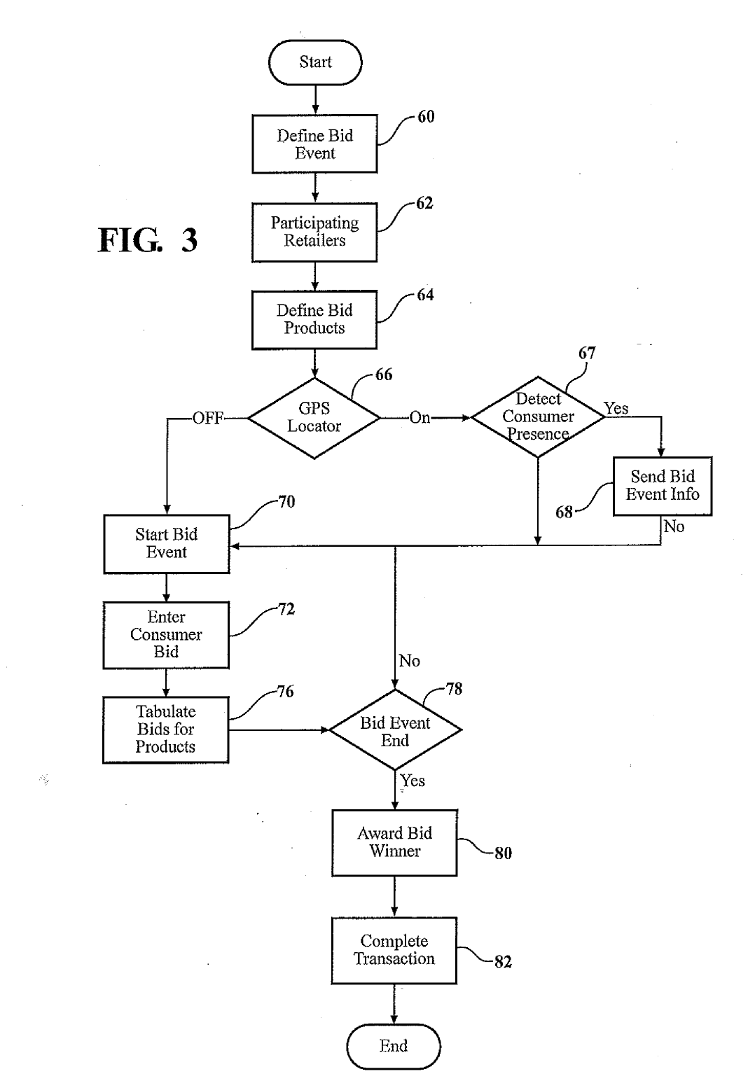

As shown in FIG. 3, in step 60, the bid products or services to be offered within a single bid period are defined. Each retailer 24, 26A-26G may provide one or more products for a particular bid period. A bid period may contain a single product from a single retailer. Alternately, a single bid period can contain multiple products from the same or a plurality of retailers within the mall.

In addition, multiple bid periods can be taking place at the same time. Each bid period will typically involve different products. However, one or more of the products in multiple bid periods can be the same.

Each bid period which can be ongoing at the same time can have different start and end times as well as providing different product characteristics, such as product price, product pick up time, the maximum number of products which can be purchased by a single consumer, etc.

The mall bid application 22 defines the terms of the bid period in step 60. For example, the mall bid application 22 can define a prescribed time period including a start day and time and an end day and time for a single bid period. By way of example, the time period can be as short as one hour or may extend over an entire business day, two or more days, one week, one month, etc.

Once the bid period 64 is established by the application 22, the application 22 will display the bid period parameters, the retail participants and the products on the mall bid website 34. This enables multiple customers or users to be able to access the website 34 to view the mall bid parameters via their mobile devices 36, 38 or from a fixed desktop 44. The same parameters and products can be simultaneously viewed on the displays 27, 29, etc.

As shown in FIG. 3, step 62 in the mall bid application 22 defines the area or mall participants which will participate in any bid event. As described above, the participants in a single mall bid or auction may include all or any or different subsets of the retailers 24, 26 shown in FIG. 2.

In step 64, the bid event products from the participating retailers in step 62 are defined. Such parameters can take a variety of forms, including photographs of the products, the product specifications, a set product purchase price, in the event of a direct purchase type bid period, etc.

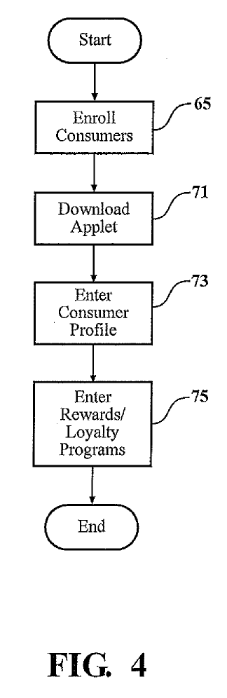

Consumers are enrolled in the mall bid program in step 65 in FIG. 4. The enrollment process can take many different forms depending upon the desired parameters of the mall bid application 22. In a simple scenario, an interested consumer can download a mall bid application or applet in step 71 from the mall bid website 34 via the Internet 32 either on premises or off premise of the mall 28. The mall applet which can be stored in the consumers mobile device 36 or 38, or in the user's PC or laptop 44, enables the consumer to communicate with the mall bid server 20 via the first communication path 35 to view ongoing or future bid event parameters, including the products offered during an ongoing bid event or in future bid events. The application also enables a consumer to place a bid during an ongoing bid event for one or more products offered during the bid event.

Each consumer can enter product preferences in step 73 to enable the mall server 20 to create a consumer profile. The profile can be provided to the mall retailers' 26A-26G to be used for marketing purposes in determining which products the retailers decide to offer during bid events. The enrollment process may also afford each consumer with the opportunity to enter any rewards or loyalty program membership numbers in step 75 for any of the retailers 26A-G present within the mall 28.

The mall bid application 22 may also implement a global positioning system (GPS) sequence to detect enrolled consumer devices 36 are GPS enabled. This enables the server 20 to immediately detect the presences of an enrolled consumer 37, such as consumer 37 shown in FIG. 2, as soon as the consumer 37 enters the geographic boundary or parameters of the mall 28. The mall bid application 22 can send a welcoming message to the consumer 37 and then offer the consumer 37 with a choice of viewing the products and bid event parameters of any ongoing bid event at the mall 28 or to review bid parameters and bid products in future bid events.

If the GPS locator function is on, as determined in step 66, the server 20 checks for an enrolled consumer 37 within the geographic parameter of the mall 28 with an active GPS enabled mobile device 36 in step 67. Upon immediately detecting the presence of such a consumer 37, the mall server 20, via the first communication path 35, sends the above described message or messages to the consumer 37 in step 68.

As shown in FIG. 2, a consumer who is present within the geographic perimeter of the mall 28 can be automatically detected by the mall server 20 via a global positioning system (GPS) embedded in the application program downloaded to the consumer's mobile wireless device, such as cell phone 36. The mall server 20 is continuously sending out interrogation messages to detect mobile devices carried by consumers which are located within the geographic perimeter or boundaries of the mall 28.

As soon as the mall server 20 detects a consumer device 36 which has the downloaded auction or bid application program within the geographic parameter of the mall server 20 sends the message via the Internet 32 through the consumer's cellular phone 36. The message may include an initial welcoming introduction text. Next, the message from the mall server 20 can include information about any ongoing bid period and invite the consumer to view the products offered during the ongoing bid period or periods. The consumer can accept or decline the invitation. If the consumer accepts the invitation to view the ongoing bid parameters and products, the mall server 20 will immediately send such information to the consumer's cell phone.

As an alternate to the GPS enabled device, the server 20 can utilize Wi-Fi networks to detect when a mobile phone or device 36, 38, etc., connects with a Wi-Fi network within the mall 28. This allows the server 20 to detect the presence of a consumer 37 in the vicinity of the mall Wi-Fi network.

In step 70, the mall bid application 22 starts a bid event. In step 72, the application 22 determines if the consumer bid is received within an ongoing bid period. The application 22 tabulates each bid for each individual product offered in the ongoing bid period in step 76. These tabulated bids for each product can be provided by the server 20 in the website 34 for viewing by each bidder or any potential consumer via their mobile devices 36, 38 or from the desktop 44. This information can also be visibly displayed in the mall 28 on the displays 27, 29, etc. Optionally, the same tabulated bids, as well as notices about upcoming bid periods and/or description of the products or services offered during a particular bid period may be displayed on one or more audio/video displays 27-31 located at various locations within the mall 28, such as within one or more retailers, i.e., screens 28 and 31 located in retailers number 1 and 5 as shown in FIG. 2, or out in front the entrances of certain retailers, or in common areas of the mall 28, etc.

Each consumer may enter more bids after viewing the tabulated bids for each product to raise his bid amount in an attempt to obtain the rights to acquire a particular product at the completion of the bid period.

The server 20, executing the application 22, when determining in step 78 that the prescribed time period has expired, closes the bid period and then, in step 80, tabulates the bids for each product offered during the bid period.

In the case where the bid period is operated as an auction, the application in step 76 tabulates the ongoing highest bid for each product offered the then current bid period. At the end of the bid period in step 78, the server 20 application, in step 80, will determine the highest bidder for each product.

In the case where bid period defines a simple sale and purchase event at a fixed product price, the server 20 application in step 76 will keep track of each consumer who placed a bid for a particular product offered during the bid period. At the end of the bid period in step 78, the application in step 80 will determine the number of consumers who have placed the bid for each product and award the purchase rights to all of such consumers. The consumer who entered the highest bid for each product is determined to be the winner of that product and is awarded the rights to purchase that product at the bid price in step 82.

In step 80, the mall bid application 22 can also provide notice to each highest bidder by the website 34 or by direct notice to each consumer's mobile device 36, 38 or desktop 44 and on the displays 27-31. The highest bidder is then given instructions in step 84 in the website 34 and by direct notice to the mobile devices 36, 38 or to the desktop 44 of a winning identification or code which identifies the highest bidder for each product as well as pickup instructions and pickup time periods for the highest bidder to go to the retailer which offered the particular product and complete the transaction.

When a consumer appears at a particular retailer who participated in a bid period, the retailer can check the consumer's credentials, i.e., driver license, identification, etc., to confirm the correct identity of the consumer as the highest bidder of a particular product. Purchase and delivery of the product is then completed by the retailer and consumer.

It will be understood that the pick up time period which set a time limit for a winning auction bidder or a bidder who merely placed a purchase order during a bid event for a particular product to pick the product up at the retailer who offered the product during the bid period can be varied from as long as 20 or 30 minutes, for example, in case of a flash sale bid event to one or more days or even a week for auction products. The available of online payment and shipping from the mall 28 to the consumer is also possible.

The completion of the transaction step 82 may take a variety of alternate forms. For example, a consumer who placed the highest auction or who placed a validated direct purchase bid for a product offered during a bid period can use his mobile device 36, 38, etc., or his PC or laptop computer 44 to complete the transaction online. The completion of the transaction can thus take place via online payment processing.

Pickup of the product by the consumer can also take a variety of forms, including the requirement to have a consumer appear at the retailer within a set period, as described above, to pay for and pick up the product. Alternately, the consumer can arrange for the product to be shipped to an address provided by the consumer.

It will be understood that the mall bid application 22 may conduct multiple bid periods at the same time, each bid period covering a different group of products and different or the same bid time periods.

The website 34 may also include details of each product offered in a particular bid period. This enables consumers via their mobile devices 36,38 or desktop 44 to obtain further information about each product to enable the consumer to determine if he or she wishes to make a bid for a particular product. Such product details may also be provided by the application 22 through the server 20 to the individual displays 27-31 within the mall 28. Such displays 27-31 can illustrate each product in a consecutive basis.

The mall bid application 22 enhances consumer interest in products offered at a mall 28 and thereby drives consumer traffic to the mall 28, either to view the products offered in a particular auction, as well as to pick up and pay for the products awarded to the highest bidder in a bid period.

The ability of a consumer to access the website 34 to determine the products offered in one bid period, when the bid period takes starts, the time period of the bid period, as well as a tabulation of current bids for each product offered in a bid period, can be completed when the consume is within the confines or perimeter of the mall 28 or remote from the mall 28, such as in the user's home, work place, etc.

If a particular consumer sees a product offered during a particular bid period that he or she is interested in, the consumer can either access the website 34 to obtain further information about the specifications of the particular product as well as proceeding to the mall 28 to view the product in person at the particular retailer.

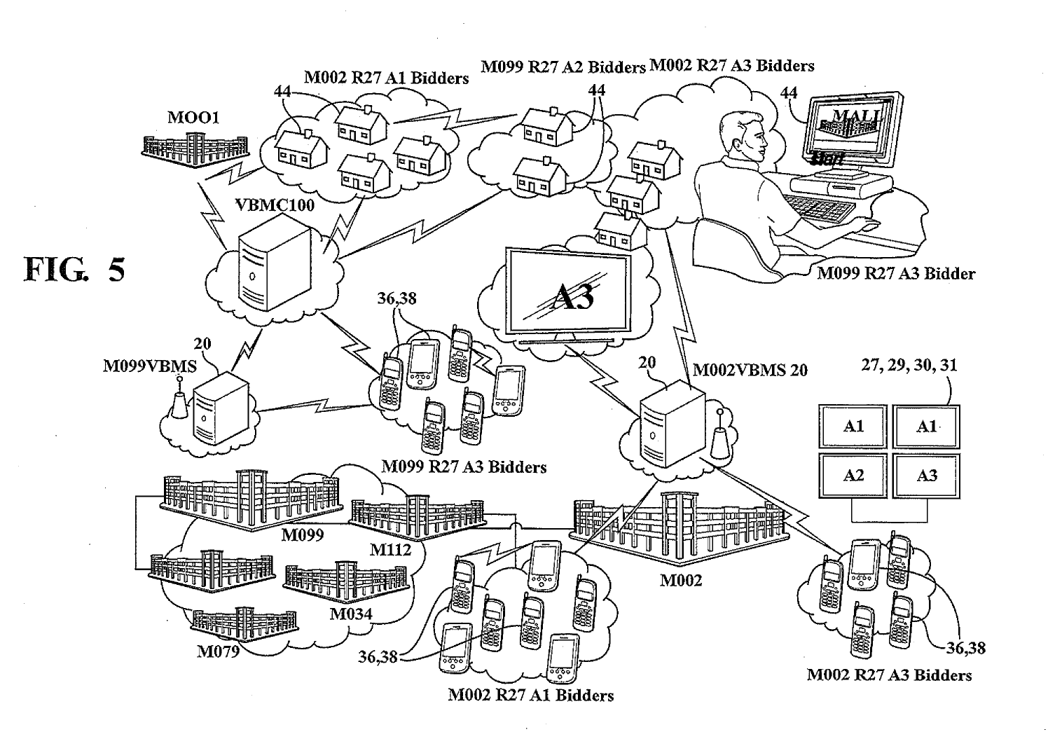

Referring now to FIG. 5, there is depicted an alternate arrangement for the mall bid program and system.

FIG. 5, depicts a multiple mall system in which at least certain of the malls, such as malls M0099 and M002, have a server 20, as described above, consumers wireless mobile devices 36 and 38, for example, as well as consumer home or remote from each mall PC's, such as a home based personal computer or laptop 44 communicating through the first wireless communication network described above and shown in FIG. 1, with either a mall base server 20, also referred to a Virtual Bid Management Server (VBMS), as well as with a remote Virtual Bid Management Control (VBMC) server 100. The VBMC 100 is in data communication via wireless and/or hardwired networks with each of the mall, such as malls M001 and M009, M002, M034, M079 and M112 through a data communication pathway including the Internet, Ethernet, and/or satellite communication, etc.

The VBMC 100 provides overarching logic for an array of possible mall bid program events including “Auction Event Distribution Scenarios”, unique mall bid instances, “Virtual Community Parameters” based on user relationships or “Virtual Auction Perimeter Handling”. For example, while a VBMS 20 at mall 009 could concurrently host independently defined bid periods or auctions A1 A2 and A3, each offering multiple products in mall M009 for one or more retailers, retailers R27, for example, and bid events or auctions A1 and A3, R29, for a different retailer, R299 for example, in the same mall M009, the VBMC 100 could assist in controlling the when and how a plurality of malls and bidders are included or notified of the bid event or auction A1 for retailer R27 in mall M009, (or some combination retainer 27 bid events or periods, such as only A1 or A3), if, in fact, retailer R 27 participating in the bid event in mall M009 is located in a plurality of malls defined in a desired “channel grouping”, such as malls M009, M112, M002, etc.,

Another example of a handling function between the VBMC 100 and a VBMS 20 in one of the malls, is the application of a high frequency “bid radius” computation grid that weighs the competing values of cleared/registered on-premise bids against off-premise bids prior to the close of a bid event, and the probability of new bids to clear prior to close of the same bid event period. This handling function can be accomplished in different algorithmic manners and for several economic reasons, including the need to sequence retail bid event distributions and notifications to user groups and bidders that may raise the value of product bids offered during the bid period, or to increase the probability that all of the gross retail inventories will sale in the bid period.

The VBMS 20 independently or asynchronously at each of or concurrently (synchronously) at multiple mall locations M009, M002 and M112, for example, will poll for audience estimation and provide a projected number of possible new bids within the remaining bid period time based on numerous variables including, but not limited to, for example: 1. the sum of all cleared/registered on-premise and off-premise bids for a specific bid event products and their competing bid value tabulations prior to the close of a bid period; 2. the sum detection of on-premise devices by means of GPS, Wi-Fi, etc., prior to the close of the bid period that have not yet placed a competing bid for current bid event products, but are historically known as authenticated enrolled users, of having bid on products in the past; 3. some detection of off-premise devices by means of GPS, Wi-Fi, etc., prior to the close of a bid period that have not placed a competing bid for current bid event products, but are known enrolled users having bid on products in the past; 4. registered live tune-ins via the Internet 32 to the bid website 34 channels of consumers that have not yet placed a bid for current bid event products, but are known enrolled users having bid products in the pas; and 5. competing value tabulations of all current and historic bid sets. The VBMS 20 and VBMC 100 can also handle relational retailer data, such as current transaction volumes for administration purposes.

The VBMC 100 may be set up to receive bids from bidders A1, A2, A3 from all M002 or the A3 bidders from all M009, either directly from the mobile devices or PC's of such bidders or indirectly through the VBMS server 20 at each mall M002, M001, M009.

Also shown in FIG. 5 is a direct communication pathway between the VBMC 100 and mall M001. In this instance, the VBMC 100 acts as the server 20 for the mall M001.

FIG. 5 also shows a mall bid sequence in which mall 002 A1 bidders using their home PC's or laptops 44 can place bids via the first communication pathway to bid events in the individual malls M001 and M009 through the VBMC 100 to the individual servers 20 in each mall. Alternatively, the A1, A2 and A3 bidders 44 can place bids directly to the VBMS 20 at mall M002 for bid events ongoing in the bid program in mall M002.

It should also be noted in FIG. 5, that individual bidders using either a home or mall remote located PC or laptop 44 may place bids in ongoing bid events concurrently at multiple malls, such as malls M002 and M009. It is possible for the consumers to configure which malls are included as default mall locations in his or her profile at the time of enrollment. New locations can be added manually and/or also dynamically prompted when the consumer device, 36, 38 is detected for the first time in the new mall that may be within a specific geographic perimeter of enrolled defaults or the consumer is known to have bid on relevant bid event products in the past.

Most consumers eventually visit multiple malls within a given time period, even though they may frequent or prefer to visit mall locations that are closer to their home. It is possible for a consumer that was outbid for one product of auction A3 from a retailer at mall M009 which is closer to the home of the consumer than mall M002, to still win a bid or reserve a flash sale product from the same retailer at mall M002 and still be willing to go and pickup the product. This winning bid situation could happen for a number of reasons, including the volume of competing bid values against gross inventory levels at mall M002 versus mall M009 is in the bid event period, and not just for the inventory of one product as retailer's want to maximize the number of gross items sold within a given period. The downloadable applet to each consumer device 36, 38, 44, etc., can also enable the user device to simultaneously display bids from a group of specified malls for the same, similar or multiple products.

The linked group of A1 bidders for malls M002 and the linked group of A2 bidders from mall M009 and A3 product bidders from mall M002 can directly communicate with each other via the Internet communication path for certain mall bid program events. For example, retailer event distributions which may need to rely on a shortest path between servers and consumer devices to maximize the value of each bid period event and reduce the latency of any required signaling pathways to insure speedy clearance of all bids. A consumer could download a VBMS application on his or her mobile device; connect a TV or a home PC. This application could enable signaling between more proximate VBMS and VBMC nodes. This could offer other situations, including the VBMC and VBMS enabling a subset of users or user groups using application programming interfaces and define unique bid event notifications or a closed event program specific to those users, i.e., a “Virtual Community Perimeter”. The Virtual Community Perimeter enables the subset of users to see bids of friends within the same group or social network and for retailers to see and engage bid and behavior based on user relationships.

It should also be noted in FIG. 5 that the various groups of bidders, such as the M002 mall A1 bidders, the M002 A3 bidders and M099 A2 bidders can be current user groups, either on-premise or off-premise of the malls M002 and M009 that are, for example, bidding on two different products, such as one product of auction A1 and a different product of auction A3 conducted by the same retailer in mall M002 who may also have several other bid event programs A1, A3, etc., in different configurations going on at the same time. Each bid event program can be offering one or multiple products in the same category, for example, winter coats in bid event A1, or one or multiple products in different mixed categories, i.e., children's summer clothes and women's dresses. Another program configuration could also include bid events offering multiple complimentary products in the same bid event, such as men's suits, shoes, ties, and shirts.

What is claimed is:

1. A method of selling products comprising the steps:
defining a localized area within a predetermined geographic boundary containing at least one product retailer;
providing a first communication pathway between a server and at least one consumer communication device;
establishing a second communication pathway between the server and the at least one retailer processor;
allowing the at least one retailer within the mall to offer at least one product for bid in a bid event;
establishing bid event parameters;
accepting the bids for the at least one product in the bid event from the consumers;
authorizing the purchase of the at least one product at the conclusion of the bid event at a bid price; and
completing the purchase transaction of the product by the consumer who placed the bid.

2. The method of claim 1 wherein the step of defining the localized area further comprises the step of:
defining the localized area as the perimeter of a fixed located shopping mall.

3. The method of claim 1 further comprising:
publically displaying the products offered during the bid event in the localized area.

4. The method of claim 1 further comprising the step of:
displaying the then current highest bid for each bid product during the bid event in the localized area.

5. The method of claim 1 further comprising the steps of:
determining the geographic location of a consumer; and
allowing the consumer to enter a bid during the bid event when the consumerist in a predetermined distance of the localized area.

6. The method of claim 1 wherein:
allowing a consumer to place a bid during the bid event only when the consumer is within the localized area.

7. The method of claim 1 further comprising:
downloading an application program to a mobile device carried by a consumer to facilitate bidding by the consumer during the bid event.

8. The method of claim 1 further comprising:
automatically downloading current bid event information to a consumer device containing the application program when the consumer is detected within the localized area.

9. The method of claim 1 further comprising the step of:
downloading an application program to at least one of a consumer mobile wireless device and a consumer remote processor based device.

10. The method of claim 1 further comprising the step of:
detecting the presence of a consumer within the localized area.

11. The method of claim 1 wherein the step of establishing bid events parameters further comprises the steps of:
establishing a bid period having a start time and an end time; and
communicating characteristics of the at least one product offer during the bid period to consumers.

12. The method of claim 1 wherein the step of completing the purchase transaction comprises the steps of:
verifying the credentials of the consumer with the acceptable bid for the at least one offered product from the at least one retailer; and
transferring consumer pickup of the at least one product to the consumer.

13. The method of claim 1 further comprising the step of:
receiving wireless bids from consumers for bid event products.

14. The method of claim 1 further comprising the step of:
receiving bids from consumers for the bid event products through the Internet.

15. The method of claim 1 further comprising the step of:
defining the bid event as an auction having an end time.

16. The method of claim 15 wherein the step of completing the transaction further comprises the step of:
transferring the product to the consumer who made the highest bid for an product.

17. The method of claim 15 wherein the mall server further includes:
means for visually displaying the auction products in the mall during the auction.

18. The method of claim 15 wherein the mall server further includes:
means for displaying auction bids for each auction product during the auction.

19. The method of claim 1 further comprising the steps of:
providing a virtual bid mall control; and
providing communication pathways between the virtual bid mall control and any of the consumer communication devices and the mall server.

20. An apparatus for commercial product transactions comprising:
means for defining a localized area within a predetermined geographic boundary containing at least one product retailer;
means for providing a first communication pathway between a server and at least one consumer communication device;
means for establishing a second communication pathway between the server and the at least one retailer processor;
means for allowing the at least one retailer within the mall to offer at least one product for bid in a bid event;
means for establishing bid event parameters;
means for accepting the bids for the at least one product in the bid event from the consumers;
means for authorizing the purchase of the at least one product at the conclusion of the bid event at a bid price; and
means for completing the purchase transaction by the consumer who placed the bid.

21. An apparatus for commercial product transactions comprising:
a mall server;
a computer network of at least one retailer within a localized area within a predetermined geographic boundary defining a shopping mall;
a first communication pathway providing communication between the mall server and at least one of a mobile wireless device and a computer processor associated with a consumer;
a second communication pathway providing information between the mall server and the retailer network to facilitate the establishment of a product bid period offering at least one product from the at least one retailer for sale;
the mall server facilitating bid event characteristics through the first communication pathway between the at least one consumer device and the mall server to receive bids from the consumer via the at least one consumer device for the at least one product offered during the bid period; and
the at least one consumer communication device including a software application which is capable of receiving bid event characteristic information from the mall server and to enter bids from the consumer to the mall server for the at least one product offered during the bid event.

22. The apparatus of claim 21 further comprising:
a virtual bid management control server disposed in data communication with any of the at least one consumer communication device and the mall server to facilitate information exchange between the at least one consumer device and the mall server;

23. An apparatus for purchasing products by a consumer comprising:
each consumer having a communication device;
a server transmitting product information offered during a bid event from a plurality of retailers located within a predetermined geographic boundary;
the server receiving product purchase bids from the consumers for the products offered during a bid event by a first communication pathway; and
authorizing the purchase of the products by consumers at the completion of the bid event;

24. The apparatus of claim 24 further comprising:
the retailers within the predetermined geographic boundary coupled by a second communication pathway with the mall server for exchanging information relating to the products offered by the retailers in a bid event and purchase information relating to consumers making a bid.
